(19) United States
(12) Patent Application Publication
(10) Pub. No.: US 2018/0339853 A1
(43) Pub. Date: Nov. 29, 2018

(54) CONTAINER ANCHORING SYSTEM

(71) Applicant: Milton Tapia, Port Washington, NY (US)

(72) Inventor: Milton Tapia, Port Washington, NY (US)

(21) Appl. No.: 15/604,636

(22) Filed: May 24, 2017

(51) Int. Cl. B65F 1/14

(52) U.S. Cl. CPC B65F 1/14

(57) ABSTRACT

A container anchoring system comprises a container releasably attached to an anchor. The anchor has an upper portion and a surface contacting element, wherein the surface-contacting element is attached to the upper portion, and wherein a bottom surface of the container is configured to receive the upper portion.

### CROSS-REFERENCE TO RELATED APPLICATION(S)

Not applicable

### BACKGROUND OF THE INVENTION

### 1. Field of Invention

The present invention relates to the field of anchoring means. More particularly to anchoring means for containers such as trash cans.

### 2. Description of Related Art

Containers are used to retain a variety of objects placed therein. The intended use dictates the required dimensions of the containers and placement of the container can present multiple issues. While some container used to retain trash are placed inside of a building having generally flat floor surfaces, trash containers or receptacles are often needed on uneven surfaces.

Trash container placement at outdoor locations can include parks and beaches or temporary event venues. Often these locations provide for inclines or declines in the topography presenting a physical challenge to the placement and stability of a trash can disposed thereon. Even inside of a building, placement of a trash can on a flat surface is still subject to displacement where someone or something contacts the can with enough force to overturn it.

Currently, attempts have been made to address outdoor placement of trash cans. However, such attempts have only included permanent placement whereby a frame or substructure is provided for mounting the trash container to a surface. For example, where a concrete exists bolts are inserted into the concrete to connect the can to the ground. Other options exist where the container is constructed of very dense and heavy materials to lower a center of gravity or increase the amount of necessary force to displace the container.

Similarly, indoor containers may have a slip resistant bottom surface or a weighted bottom surface to try and prevent displacement. None of these current options provide a suitable reliable solution.

Based on the foregoing, there is a need in the art for a system to retain a container to a surface in a manner that is permanent until a user would desire to move or transplant the container to a new location. Essentially a removable anchor system and container specifically configured to engage the anchor in communication with a floor or ground surface.

### SUMMARY OF THE INVENTION

A container anchoring system comprises a container releasably attached to an anchor. The anchor has an upper portion and a surface contacting element, wherein the surface-contacting element is attached to the upper portion, and wherein a bottom surface of the container is configured to receive the upper portion.

In an embodiment, the anchor further comprises an anti-oscillation plate having a hollow interior extending through the surface contacting element to the upper portion, wherein a spring is disposed within the hollow interior, wherein the spring dampens movement between the container and a substrate.

In an embodiment, the surface contacting element has one or more protrusions extending downward in an opposite direction from the upper portion, wherein the one or more protrusions positively engage a substrate, wherein the anchor retains the container to the substrate.

In an embodiment, the anchor has one or more connecting means configured to retain a substrate, wherein the one or more connecting means are angled, and wherein the anchor is rotated into the substrate.

In another embodiment, the connecting means are perpendicular to the base such that they engage the substrate generally perpendicular to the substrate. For example, in such an embodiment, the connecting means are pressed into the substrate by a user stepping on the surface element.

In an embodiment, a distance between the upper portion and the surface contacting element is adjustable, wherein the upper portion is threadingly engaged to the surface contacting element, and where the distance is adjusted by rotating the upper portion out of the threading engagement.

In an embodiment, a distance between the upper portion and the surface contacting element is adjusted to a predetermined length and retained in place with one or more releasable clips.

In an embodiment, the surface contacting element further comprises a helical protrusion extending outward from a bottom of the surface contacting element, wherein the helical protrusion springingly engages a substrate.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the container anchoring system, according to an embodiment of the present invention;

FIG. 2 is a perspective view of the container anchoring system, according to an embodiment of the present invention;

FIG. 3 is a perspective view of the container anchoring system, according to an embodiment of the present invention;

FIG. 4 is a perspective view of the container anchoring system, according to an embodiment of the present invention;

FIG. 5 is a perspective view of the container anchoring system, according to an embodiment of the present invention;

FIG. 6 is a perspective view of the container anchoring system, according to an embodiment of the present invention; and

FIG. 7 is a perspective view of the container anchoring system, according to an embodiment of the present invention.

### DETAILED DESCRIPTION OF PREFERRED EMBODIMENTS

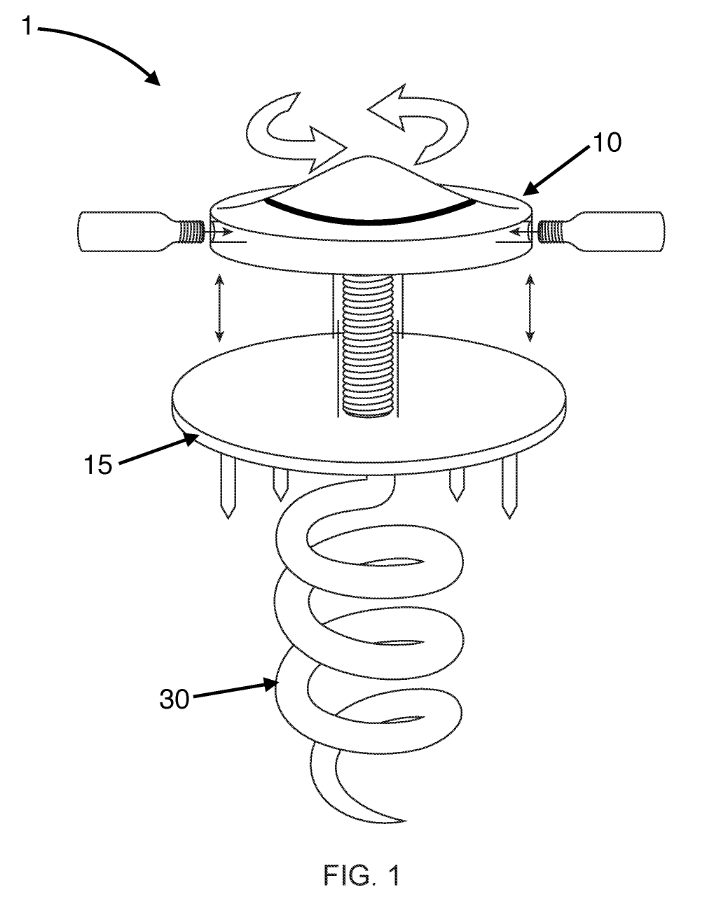

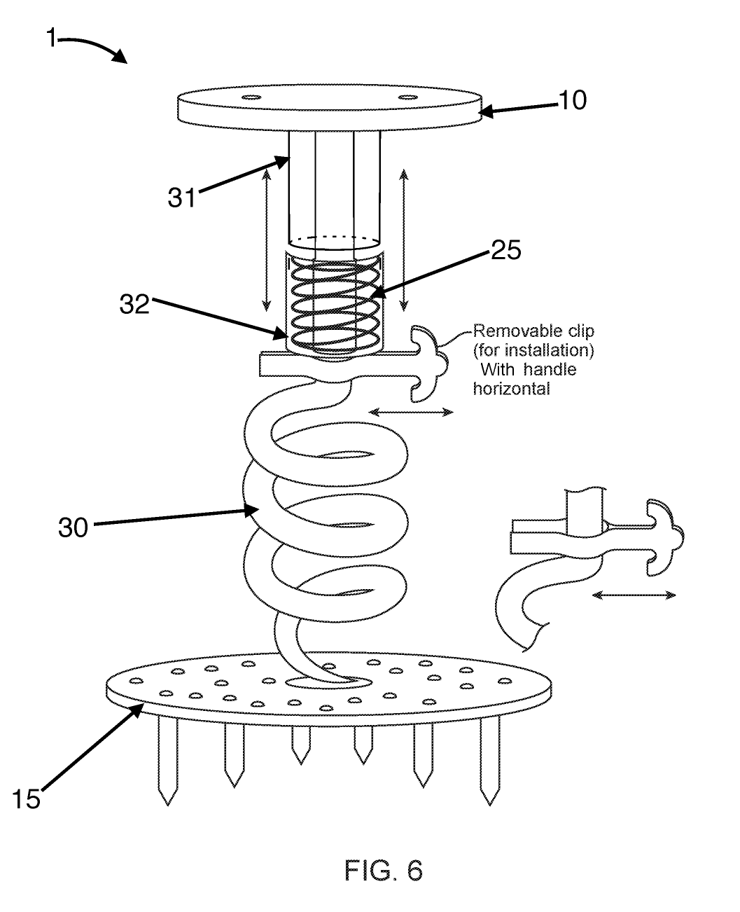

Preferred embodiments of the present invention and their advantages may be understood by referring to FIGS. 1-7, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

A container anchoring system 1 has an anchoring means and a container 5. The container 5 has at least a bottom surface with one or more sidewalls extending upward therefrom. Where the container 5 has a circular or similar shape, the sidewall may be considered singular as it would extend upward from a perimeter of the bottom surface. The anchoring means has a protruding upper element 10 disposed generally on top of a surface contact element 15. The bottom surface of the container is configured to engage the protruding upper element 10 such that the container 5 is releasably attached to the anchoring means.

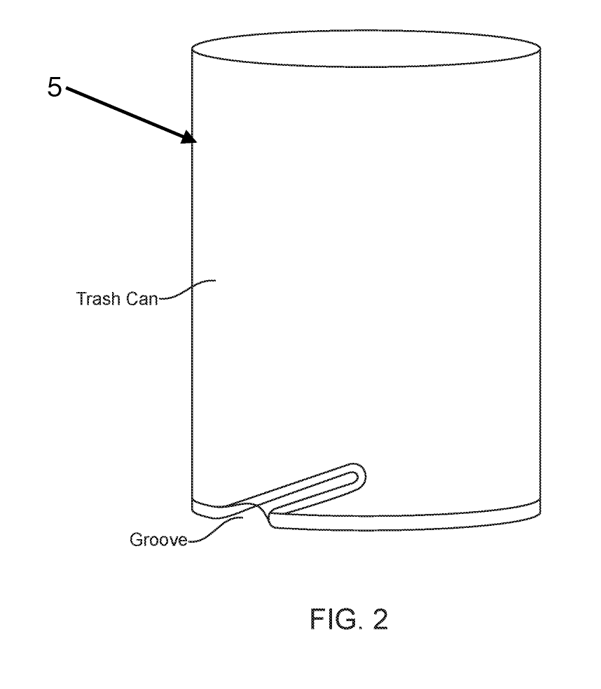

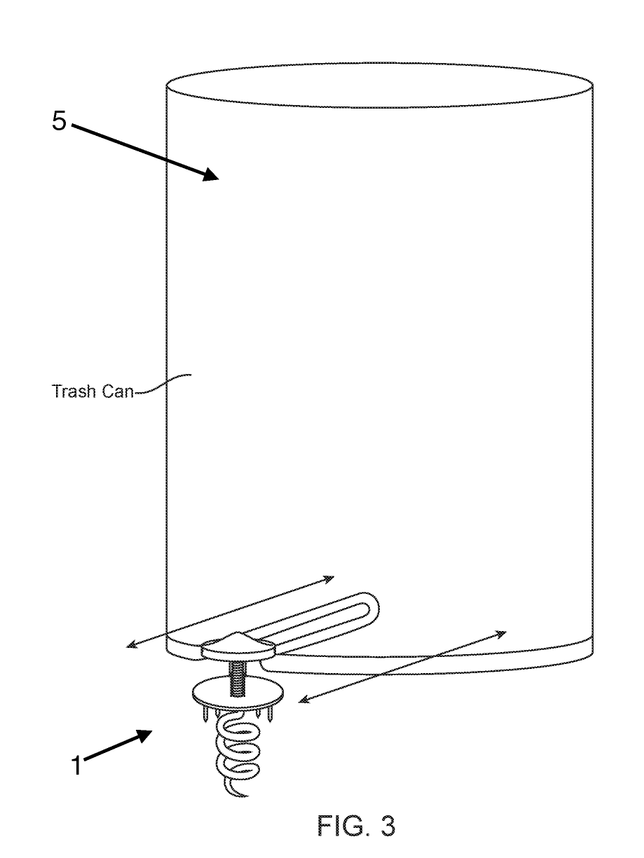

FIGS. 2 and 3 illustrate where the bottom surface of the container 5 has an irregular surface area modified to accept the particular configuration of the protruding element. Where the protruding element 10 provides for a shank connecting a head of the protruding element to the surface contact element.

The surface contact element 15 is configured to positively engage a surface such as a floor or ground where the container is placed outside of a structure.

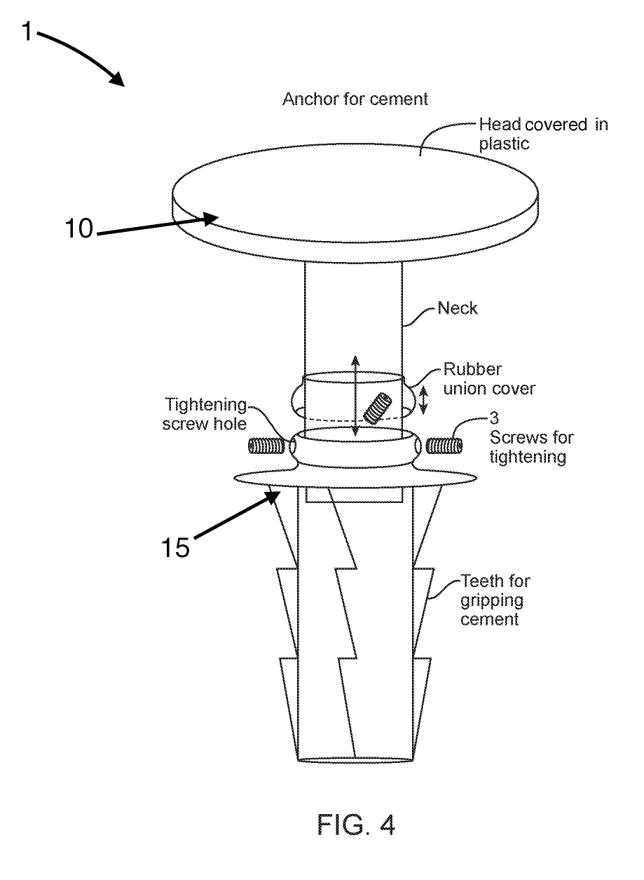

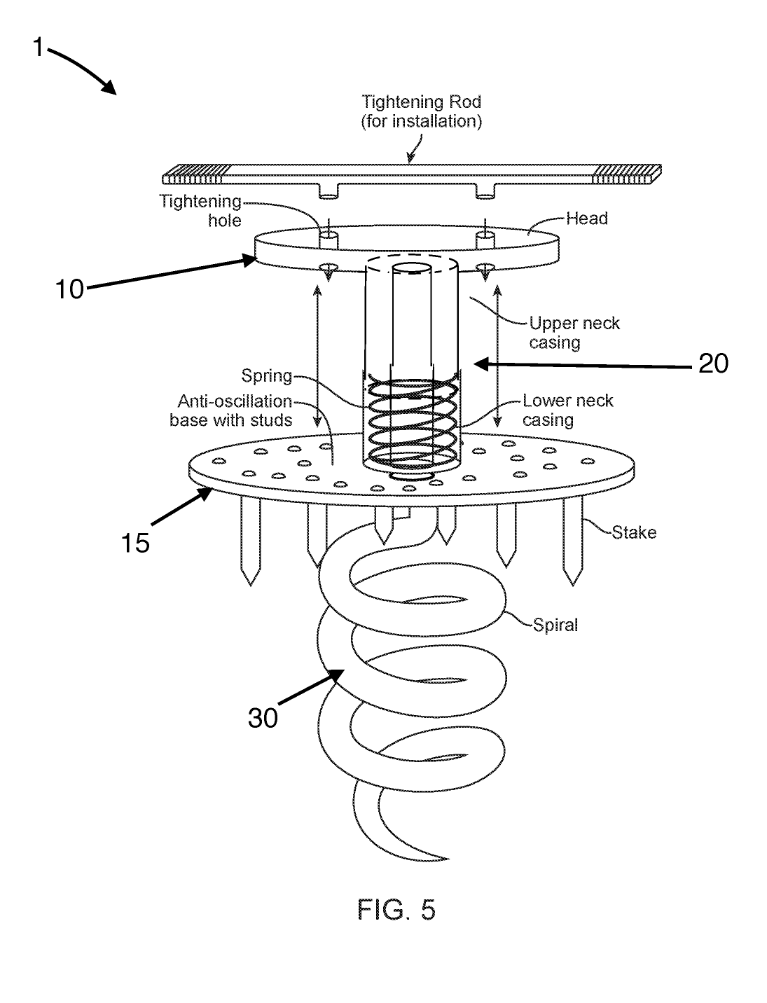

FIGS. 4 and 5 illustrate that the surface contact element 15 acts as an anti-oscillation component 20 to prevent or dampen shock from contact between the container 5 and come other object. As forces of the contact are transferred through the container, the surface contact element distributes the forces into the ground and dampens any excessive shock to prevent dislodging or tipping of the container.

In the embodiment, where the surface contact element 15 is an anti-oscillation plate 20, it is configured in various ways. For example, the anti-oscillation plate, which has a first configuration with studs and a second configuration without, studs. The studs are the first part to be installed. For example by simply by pushing the studs into the ground, such that the anti-oscillation plate prevents loosening and oscillation of the neck/head with repetitive use; and provides a base upon which the container can easily slide into communication with. The anti-oscillation plate further provides counter resistance between helical element and head. Such function is facilitated by a spring mechanism 25 disposed within a hollow interior of the surface contact element to dampen movement received from the container.

In an embodiment, once the anti-oscillation plate is in place, the helical element 30 is threadingly engaged and the spring mechanism 25 in the neck not only allows for regulation of the height but also holds the surface contact element firmly in place with respect to the neck and head.

In one embodiment, the surface contact element 15 has a helical element 30 extending outward in an opposite direction of the protruding element. The helical element 30 allows for a screw or threading engagement with a surface whereby a user rotates the surface contact element into the surface until the desired depth of engagement or strength of engagement is reached.

In another embodiment, a single spike element is provided at the bottom of the surface contacting element such that the spike extends outward in an opposite direction of the protruding element. The single spike may comprise teeth or serrations to promote more surface area to contact with sub-surface material. For example, the single spike has a plurality of teeth disposed on an exterior surface of the spike. A user forces the spike into the surface. The surface is either backfilled with material, or subsurface material automatically backfills any voids created by the teeth. The teeth then provide for increased surface area of the spike preventing easy removal of the anchoring means.

In another embodiment, the surface contact element provides for a plurality of spikes extending in an opposite direction of the protruding element. The spikes may be provided in combination with other surface contacting elements such as the helical element. The spikes provide for redundant and additive strength in the connection between the surface contact element and the surface. In an alternative embodiment, the plurality of spikes are uniformly angled allowing for a semi-rotational installation whereby a user contacts a surface with pointed tips of the angled spikes. Then, turning the surface contacting element, the spikes will promote close contact and a positive engagement with the surface.

Where the spikes allow, the installation is performed by simply stepping or providing other downward force on the element to inject the spikes into the ground or surface. In such an embodiment, the spikes extend perpendicular to the surface contacting element such that the spikes extend straight out from the element.

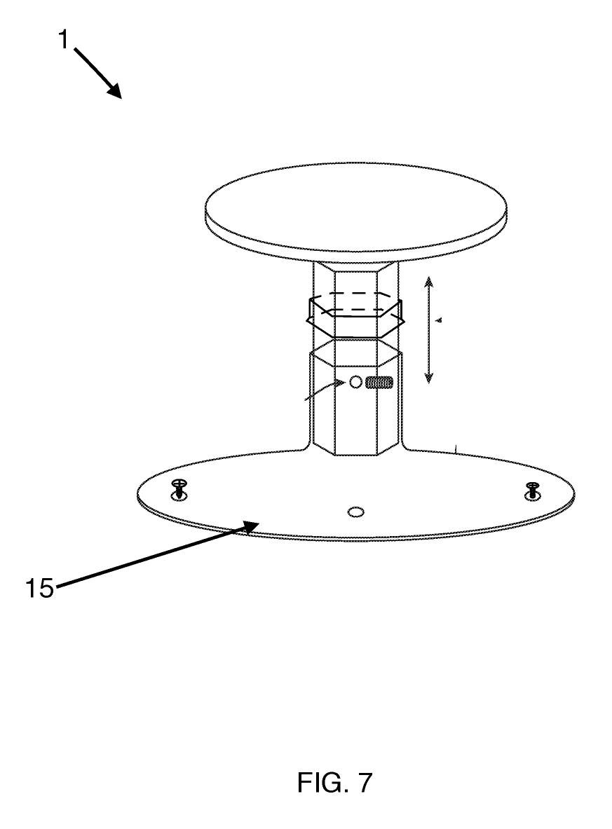

In an embodiment, FIGS. 4 and 7 illustrate that the distance between the head of the protruding element is adjustable relative to the surface contacting element. The shank or neck may be threadingly or telescopically engaged with the head and/or the surface contacting element. Where the container placement or bottom surface requires the head to be extended beyond an initial position, the shank is rotated to extend the head upward, further away from the surface contacting element to accommodate the extended positioning required by the container.

In an embodiment, the protruding element is attached to the surface contacting element whereby a collar extends upward from the surface contacting element on an opposite side of the spikes. The collar receives a collar 31 extending from the protruding element whereby the collar 31 of the protruding element has a diameter, which is smaller than the surface element collar 32. A spring disposed within the protruding element collar biases the protruding element away from the surface contacting means while a locking mechanism retains the two collars slidably within one another. The spring acts as a further dampener to absorb shock from the protruding element.

In an alternative embodiment, the protruding element is slidably engaged to the surface contact element whereby the shank or neck has a hollow interior accommodating a shank with a smaller cross section to be disposed therein. In this embodiment, the length of the protruding element is predetermined and the protruding element is pulled away from the surface contacting element until such length is achieved. To set the position of the protruding element, one or more sets of screws are provided to lock the protruding element in the extended position.

In one embodiment, the protruding element engages the surface contacting element through a quick-disconnect fitting. The fitting has a spring biased locking mechanism. When in a closed position, a collar is positioned over a plurality of ball bearings biasing them into corresponding holes of an interior collar, thereby locking the exterior collar to a set position. By pulling down on the exterior collar of the quick disconnect mechanism, the balls are leased from their locked position and allow release of the protruding element.

Where the protruding element is threadingly engaged to the surface contacting element, a tightening rod is provided having a length and at least two protruding extensions disposed between ends of the length. The two protruding extensions are configured to engage two depressions in the protruding element allowing for increased torque during rotation when threading the protruding element to the surface contacting element. The rotation is continued until the desired distance between the head of the protruding element and the surface contacting element is achieved.

In an alternative embodiment, the container anchoring system is installed in a vehicle or watercraft. For example, an interior surface of a boar received the surface contacting element. The surface contacting element may be releasably engaged to the interior surface of the boat through adhesive or another fastener means. The container engages the protruding element thereby retaining the container in position preventing displacement during pitch and yaw of the boat. In a specific example, the container is a cooler having the groove disposed on the bottom to receive the protruding element when installed on the boat.

In an embodiment, the protruding element has a visual indicator. The visual indicator provides illumination or reflection of light to indicate a position of the protruding element. The visual indicator may be passive or active, whereby an active indicator is connected to a power source and the light emitted is due to a light bulb or light emitting diode. In such an embodiment, the visual indicator prevents undesired contact between a person and the protruding element when the anchor is installed.

The visual indicator is helpful to both prevent people from tripping over the protruding element, as well as helping to locate and align the protruding element with the groove in the container.

In another illustrative application, the anchor provides for retention of pots for plants or exterior decorations. In such an embodiment, the pot is molded to incorporate the grove to accept the protruding element. While this is an illustrative example, the size and shape of the protruding element along with the corresponding groove can vary based on the particular application.

In another illustrative embodiment, the anchor system operates in conjunction with a beverage container. The beverage container has a groove corresponding to the protruding element allowing a user to releasably attach the beverage container to the anchor. In such an embodiment, the anchor may be modified to attach to a chair, table, or other surface where a user may regularly position a beverage container.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A container anchoring system comprising:
a. a container;
b. an anchor having an upper portion and a surface contacting element, wherein the surface contacting element is attached to the upper portion, and wherein a bottom surface of the container is configured to receive the upper portion.

2. The system of claim 1, wherein the anchor further comprises an anti-oscillation plate having a hollow interior extending through the surface contacting element to the upper portion, wherein a spring is disposed within the hollow interior, wherein the spring dampens movement between the container and a substrate.

3. The system of claim 1, wherein the surface contacting element has one or more protrusions extending downward in an opposite direction from the upper portion, wherein the one or more protrusions positively engage a substrate, wherein the anchor retains the container to the substrate.

4. The system of claim 1, wherein the anchor has one or more connecting means configured to retain a substrate, wherein the one or more connecting means are angled, and wherein the anchor is rotated into the substrate.

5. The system of claim 1, wherein a distance between the upper portion and the surface contacting element is adjustable, wherein the upper portion is threadingly engaged to the surface contacting element, and where the distance is adjusted by rotating the upper portion out of the threading engagement.

6. The system of claim 1, wherein a distance between the upper portion and the surface contacting element is adjusted to a predetermined length and retained in place with one or more releasable clips.

7. The system of claim 1, wherein the surface contacting element further comprises a helical protrusion extending outward from a bottom of the surface contacting element, wherein the helical protrusion springingly engages a substrate.
